(19) United States
(12) Patent Application Publication
(10) Pub. No.: US 2013/0239224 A1
(43) Pub. Date: Sep. 12, 2013

(54) METHOD OF LOCATING A COMPUTING DEVICE

(71) Applicant: Alexander Kariman, (US)

(72) Inventors: Alexander V. Kariman, Rockville, MD (US); Andrew V. Bardachenko, Obuhov (UA); Oleksandr Rashkevich, Vinitsa (UA)

(73) Assignees: TRUE SECURITY LLC, Rockville, MD (US); Alexander Kariman, Rockville, MD (US)

(21) Appl. No.: 13/855,931

(22) Filed: Apr. 3, 2013

(30) Foreign Application Priority Data
Aug. 6, 2008 (UA) 40359

(51) Int. Cl. G06F 21/55

(52) U.S. Cl. CPC G06F 21/552
USPC 726/26; 717/176

(57) ABSTRACT

The method of location tracking of a computing device (computer, notebook, mobile phone, etc.) that can be used to prevent unauthorized access and/or theft of the device. The essence of the invention is that special software is installed on the computing device that can obtain external and internal IP-addresses of the Internet enabled computing device. The special software then processes this information and forms an electronic massage that includes IP-addresses and an identifier of the computing device. Special software then sends this message to an electronic address preset by the user of the computing device. Only the user of the computing device and the special software installed on the computing device has access to such electronic address.

### FIELD OF THE INVENTION

The invention relates to the methods of locating a computing device (PC, laptop, mobile phone, etc.) in order to prevent unauthorized access and/or device theft.

### BACKGROUND

A known method and product (U.S. Pat. No. 5,764,892, GO6F 1/00, GO6F 21/00, HO4L 12/24, HO4M 003/00, GO8B 013/22, dated Jun. 9, 1998) that constitutes a computing device security system. The essence of this system is that special security software, either openly or secretly, is installed on the computing device that periodically transmits to the central station a report containing encrypted device serial number and this report is simultaneously delivered to the user of the device by communication means. The central station receives such report from the computing device, compares the serial number against a known encrypted serial number and accepts or rejects the report.

The shortcoming of this known system is that it is dependent on a particular communication channel, namely the telephone line that it uses to track the location of a computing device. This system is also capable of locking the computing device without consent of the device user, even if the change in the device location took place with the user's knowledge but without notifying the central station if a computing device, for example, was not connected through a modem to the telephone line. Thus, the known method does not meet requirements of the device user.

A known method (U.S. Pat. No. 6,300,863, GO6F 11/00, HO4L 12/24, GO6F 1/00, GO6F 21/00, HO4L 12/26, HO4Q 7/32, GO6F 007/00, dated Oct. 10, 2001) that represents a computing device security system. The essence of this system is that special security software is installed on the computing device, either openly or secretly, that periodically transmits to the central station a report containing an encrypted device serial number. The monitoring station receives such report via any communication means, compares it with the known encrypted serial number and accepts or rejects such report. This system also allows delivering such reports that contain the device location information to the user's address, whether through email and/or phone.

The shortcoming of this system is that it is quite cumbersome because it involves a monitoring station that is an extra link in providing notifications about the device location to its user.

The closest analog to the claimed method is a way of determining a computing device location via network (U.S. Pat. No. 7,100,204, GO6F 12/14, HO4L 9/32, dated Aug. 29, 2006). This method involves installation of special software on a computing device that determines physical device location using IP address. The method requires a constant connection to the Internet and a facilitator that has an essential database. The facilitator, using a specialized database, tracks physical device location by periodically comparing the device IP addresses. The facilitator collects information about the computing device location, classifies it and captures it on a special map and posts it on a special website. The movement of a computing device is approved on-line by its owner confirming the IP addresses as accepted. If the change of location of the computing device on the map is not accepted by its owner via a special website, the computing device will be locked.

The disadvantage of the known method is that the presence of a specialized website is required to maintain constant on-line communication, exposing the computer owner to additional monetary costs and distraction from the computer use.

### DESCRIPTION OF THE INVENTION

The technical goal of the claimed invention is to improve the way of locating a computing device (PC, laptop, mobile phone, etc.) that has access to the Internet, by identifying the IP address in order to prevent unauthorized access to the device and/or device theft. The claimed improved method simplifies the known similar methods and systems designed to prevent unauthorized access to the data residing on a computing device, and designed to provide assistance in locating the Internet enabled computing device (PC, laptop, mobile phone, etc.).

The essence of the utility model is that special software (SS) is installed on the computing device that determines the current internal and external IP addresses of the computing device, processes the information, generates an electronic notification containing the current internal and external IP addresses of the device and sends the notification to a user preset electronic address. Only the user of the computing device and the SS has access to the electronic address; and the address is preset by the user and serves as an identifier of the computing device.

The technical result is achieved by installing SS on the computing device. The SS assigns an identifier to the device, determines the current internal and external IP addresses of the device, processes the information and generates an electronic notification that contains external and internal IP addresses. Such electronic notification is transmitted to a user preset electronic address accessible only by the user and the SS located on the computing device. Thus, the method claimed provides confidentiality of data contained in the messages, and enables the user to identify the message that was sent to the specified electronic address as a message from the SS. User can then obtain the IP-addresses of the computing device, and use the IP-address to determine location of the computing device.

The user of the SS equipped computing device can use the above mentioned electronic address, assuming the existing Internet connection, to exchange notifications and commands with the SS installed on the computing device, where such commands are encoded with an encryption key known only to the user and the SS installed on the device. Thus, the method claimed provides confidentiality, integrity and authenticity of data contained in the message.

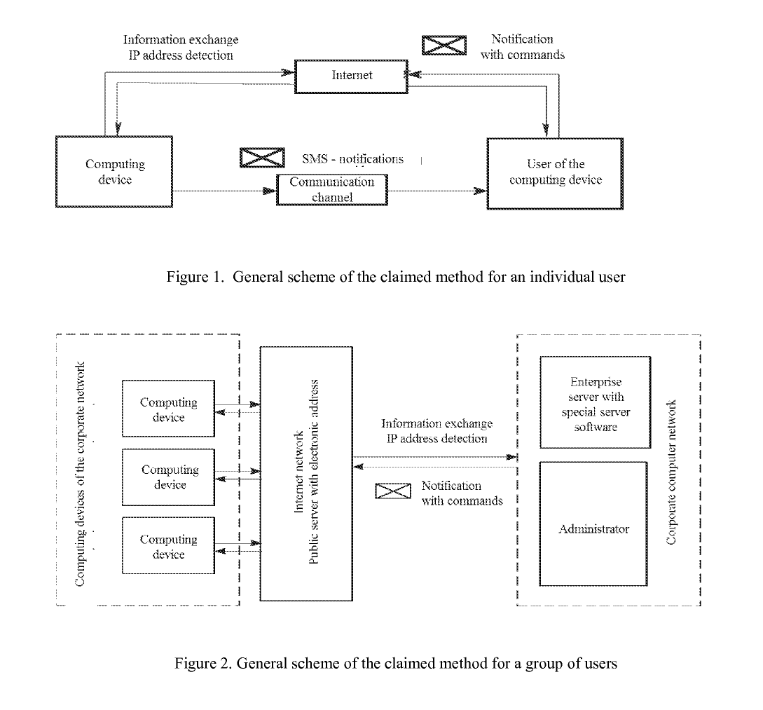

The FIG. 1 (Method of locating a computing device) shows a general scheme of the claimed method for an individual user.

The FIG. 2 (Method of locating a computing device) shows a general scheme of the claimed method for a group of users.

An example of embodiment of the claimed invention:

### EMBODIMENT 1

Special software is installed on the computing device that assigns an identifier to the device, determines the current internal and external IP addresses of the device, processes the information and generates an electronic notification that contains external and internal IP addresses and sends this notification to an address preset by the user, specifically an email address (e-mail). Only the user of the computing device and the SS installed on the device has access to such electronic address. Thus, the method claimed ensures confidentiality of data contained in the notification, and enables the user to identify the notification sent to the specified email address as a notification from the SS. User can then obtain current IP-addresses of the computing device from the notification, and use these IP-addresses to determine the location of the device.

The user of the SS equipped computing device can use the above mentioned electronic address, assuming the existing Internet connection, to exchange notifications and commands with the SS installed on the computing device, where such commands are encoded with an encryption key known only to the user and the SS installed on the device. Thus, the method claimed provides confidentiality, integrity and authenticity of the data contained in the notification. The e-mailed electronic notification from the SS may be delivered via SMS-message or other communication channels to a telephone or another communication device.

If the location of the computing device is unknown, user may, at its own discretion, send a command that is enclosed in a user-generated special notification to the SS in order to deactivate a computing device and/or destroy the user specified data located on the device, so as to be destroyed in the event of unauthorized access. SS is able then to identify the electronic notifications as messages from the user when they arrive to a preset electronic address, in this case an e-mail address.

### EMBODIMENT 2

Special software (SS) is installed on the computing device where such device is a part of a computer network, for example a corporate network. The SS assigns to the device an identifier, determines the device current internal and external IP addresses, processes the information and generates an electronic notification that contains external and internal IP addresses and sends this notification to an address preset by the user, more specifically an email address (e-mail). Special server software (SSS) is installed on the enterprise server, which has a database of all email addresses used to communicate with the corporate computing devices. Thus, the SSS has the ability to automatically or via a special command from an administrator, centrally receive messages from all email addresses (all computing devices) and centrally send messages that contain commands from an administrator to all e-mail addresses (all computing devices). Only the SS of the specific computing device and the SSS have access to each specific email address. Thus, the method claimed ensures confidentiality of the data contained in the notification, and enables the SSS and/or administrator to identify notifications that are received at the specified email address as notifications from the specific SS. SSS and/or administrator can then obtain IP-addresses of computing devices and use these IP-addresses to identify their location.

The SSS located on the corporate server and the SS located on the computing device may use the above mentioned exchange of email notifications and commands where such email notifications and commands are encoded with an encryption key known only to the SSS (stored in the corporate server database) and the SS that is installed on the computing device. Thus, the method claimed provides confidentiality, integrity and authenticity of data contained in these messages.

In case if the corporate computing device location is unknown, administrator is able, at its own discretion, to issue appropriate commands enclosed in a special message created by administrator and send such message to the SS in order to deactivate the device and/or destroy specific data located on the device, as configured by administrator, as such, to be destroyed in the event of unauthorized access. In case if the corporate computing device location is unknown, the SSS is able to automatically issue the appropriate commands enclosed in a special notification formed by the SSS and send such notification to SS in order to deactivate the device and/or destroy specified data located on the device, as configured by the administrator, as such, to be destroyed in the event of unauthorized access. The SS located on the computing device is able to identify the notifications received on the email address preset by the user (system administrator) as notifications from the user/administrator and/or from the SSS.

Therefore, the method claimed may be applied to any computing device that can be connected to the Internet, as well as a group of such devices that may be a part of computer network.

1. METHOD OF LOCATING A COMPUTING DEVICE that includes:
a) installation of special software on a computing device, where such special software assigns to the computing device an identifier;
b) such special software determines the current external and internal IP addresses of the computing device;
c) special software then processes the information, forms an electronic notification, which includes external and internal IP addresses of the computing device determined by the special software, and sends the notification via communication means to a preset by user electronic address;
d) such electronic address also serves as a confidential identifier of the computing device, and such electronic address is only accessible by the user of the computing device and the special software installed on the computing device;
e) the user of the computing device, at its own discretion, and if the Internet connection is present, sends electronic commands via such electronic address to the computing device that is equipped with a special software as to remotely manage the computing device.

2. METHOD OF LOCATING A COMPUTING DEVICE, according to the claim 1, but differ in that the notifications and commands exchanged between the user of the computing device and the special software are encoded with an encryption key that is known only to the user of the computing devices and the special software installed on the computing device.

3. METHOD OF LOCATING A COMPUTING DEVICE, according to the claim 1, but differ in that for each computing device that is a part of computer network, the special software is made up of special software installed on a computing device and special software installed on a server, where the special software installed on a server keeps track of any data obtained from each computing device, whether the device is a part of computer network or not.
